(19) United States
(12) Patent Application Publication
(10) Pub. No.: US 2022/0104642 A1
(43) Pub. Date: Apr. 7, 2022

(54) TRAINING CHOPSTICKS FOR CHILDREN

(71) Applicant: Zhifeng LIAO, Guangzhou (CN)

(72) Inventor: Zhifeng LIAO, Guangzhou (CN)

(21) Appl. No.: 17/426,209

(22) PCT Filed: May 17, 2019
(86) PCT No.: PCT/CN2019/087340

§ 371 Date: Jul. 28, 2021

(30) Foreign Application Priority Data
Jan. 29, 2019 (CN) 201920151967.8

(51) Int. Cl. A47G 21/06

(52) U.S. Cl. CPC A47G 21/103

(57) ABSTRACT

Disclosed are chopsticks for children learning, comprising: a first chopstick, a second chopstick, and a connecting assembly for connecting the first chopstick with the second chopstick, wherein the connecting assembly is provided with a connecting shaft allowing rotation of the first chopstick and the second chopstick relative to each other, and the connecting shaft is connected with a non-top portion of the first chopstick and/or the second chopstick. Therefore, it can effectively guide children to hold the chopsticks at designated positions, and the holding positions are almost the same as the positions of the fingers when actually using ordinary chopsticks. Therefore, it can effectively help children learn how to use chopsticks correctly.

### TECHNICAL FIELD

The present invention relates to the field of chopsticks, and in particular to chopsticks for children learning that helps develop children's intelligence.

### BACKGROUND

Chopsticks are used as a dining tool in many countries, especially in many Asian countries and regions, such as China, Japan, South Korea and other places. Therefore, people in these countries and regions need to learn to use chopsticks from an early age. However, many children have a lot of problems in the process of using chopsticks at the beginning. For example, they cannot use chopsticks to pick up food, which causes the food to be scattered on the table, or they use chopsticks in a wrong way which results in a slow eating speed. Therefore, how to help children quickly learn to use chopsticks is a matter of great concern to many parents.

For example, Chinese patent application No. 201510203649.8 discloses chopsticks with adjustable elasticity, comprising a left chopstick, a right chopstick, a compression spring, a tower spring, a rotating shaft, and an adjusting knob, wherein the left chopstick and the right chopstick are rotatably connected at their ends by the rotating shaft, the compression spring is provided between the left and right chopsticks, the adjusting knob is screwed into a screw hole of the rotating shaft by the tower spring, and the rotating friction between the left and right chopsticks is adjustable by rotating the adjusting knob.

However, in the process of implementing the present invention, the inventor found that children love to pull the compression spring with their hands during using chopsticks connected by a compression spring, which is easy to cause deformation of the spring, and if one end of the compression spring is disengaged, it is also easy to get people injured. On the other hand, the junction of the two chopsticks is located at the top of the two chopsticks, which is different from the actual way of using ordinary chopsticks. Therefore it cannot achieve the ideal effect of learning and is not convenient to use.

### SUMMARY OF THE INVENTION

In order to solve the problem in the prior art of lack of chopsticks that are very effective in helping children learn to use, the present invention provides chopsticks for children learning, which can effectively guide children to hold the chopsticks at designated positions, and the holding positions are almost the same as the positions of the fingers when actually using ordinary chopsticks. Therefore, it can effectively help children learn how to use chopsticks correctly.

In order to achieve the above objectives, the present invention provides chopsticks for children learning, comprising: a first chopstick, a second chopstick, and a connecting assembly for connecting the first chopstick with the second chopstick; wherein the connecting assembly is provided with a connecting shaft allowing rotation of the first chopstick and the second chopstick relative to each other, and the connecting shaft is connected with a non-top portion of the first chopstick and/or the second chopstick; wherein the connecting assembly comprises a first clamping board and a second clamping board located respectively at two sides of the first chopstick and the second chopstick upon connection of first chopstick with the second chopstick, and the first clamping board and the second clamping board are respectively provided with a connecting portion for connecting with the first chopstick and the second chopstick; and wherein an elastic element is located inside the connecting assembly, wherein when the elastic element is in a natural configuration, a picking-up portion of the first chopstick and a picking-up portion of the second chopstick are in a first configuration, and when the elastic element is in a compressed configuration, the picking-up portion of the first chopstick and the picking-up portion of the second chopstick are in a second configuration that is different from the first configuration.

In a preferred embodiment of the present application, the chopsticks further comprise a fixing ring located on the second chopstick, wherein the fixing ring is configured for receiving a fingertip of a child, and the picking-up portion of the second chopstick can be driven into rotation about the connecting shaft by the fingertip through the fixing ring.

In a further preferred embodiment of the present application, the connecting shaft of the connecting assembly cooperates with the second chopstick while the first chopstick is non-rotatable relative to the connecting assembly, and the fixing ring comprises a spiral ring such that only the second chopstick is rotatable when the fingertip of a child is inserted into the fixing ring.

In a yet further preferred embodiment of the present application, the fixing ring comprises two spiral rings, with a first end of a first spiral ring connected with the second chopstick and a second end of a second spiral ring connected with the second chopstick being in the same axial direction, and the first end of the first spiral ring connected with the second chopstick and a first end of the second spiral ring connected with the second chopstick being distributed perpendicular to the axial direction.

In a preferred embodiment of the present application, a first intersection angle is formed by the first chopstick and the second chopstick in the first configuration, and a second intersection angle is formed by the first chopstick and the second chopstick in the second configuration, wherein the first intersection angle is not equal to the second intersection angle.

In a preferred embodiment of the present application, the connecting portion comprises at least two projections for connecting with the first chopstick and also comprises the connecting shaft for cooperating with the second chopstick, and the first chopstick is provided with holes for cooperating with the projections and the second chopstick is provided with a hole for cooperating with the connecting shaft.

In a further preferred embodiment of the present application, the elastic element is provided as a bending element that is deformable, wherein the bending element comprises two ends in engagement respectively with an inner side of the first chopstick and an inner side of the second chopstick, with the engagement formed at a position closer to a top portion of the first chopstick and a top portion of the second chopstick respectively relative to the picking-up portion of the first chopstick and the picking-up portion of the second chopstick.

In a yet further preferred embodiment of the present application, the connecting assembly is provided with a projecting shaft and a projecting arc located below the projecting shaft, wherein the elastic element is provided as an elastic sheet, and the projecting arc is configured for preventing the elastic sheet from falling, and two ends of the elastic sheet are located respectively at two sides of the projecting shaft inside the connecting assembly.

In a preferred embodiment of the present application, an end of the first chopstick is provided with an arc-shaped anti-drop handle.

In a preferred embodiment of the present application, a loop for fixing a thumb of a child is provided at an outer side wall of the connecting assembly.

With the above-mentioned various embodiments of the present application, the following beneficial effects can be obtained:

1. Since the two chopsticks are connected by the connecting assembly and can be rotated relative to the connecting shaft, and the connecting shaft is provided at a position other than the top of the chopsticks, it provides a more reasonable rotating position and a more reasonable leverage, and is more ergonomic. Further, it can effectively guide children to hold the chopsticks at designated positions, and the holding positions are almost the same as the positions of the fingers when actually using ordinary chopsticks. Moreover, since the chopsticks are fixed with two clamping boards, the connecting components that connect the two chopsticks can be manufactured and assembled more quickly. Further, there are no other parts exposed, thus a more stable structure can be provided. At the same time, the two chopsticks are on the same plane, so that the problem of not being able to clamp the food due to misalignment of the chopsticks can be avoided. Through the elastic element, children can save more effort when clamping food, and the two chopsticks can automatically restore their initial configuration.

2. The child's fingertips are received in the fixing rings, which greatly increases the contact area between the fingers and the rings, making it not easy to loosen; and the child's fingertips can drive the picking-up portion of the second chopstick to rotate about the connecting shaft through the fixing ring, which can better guide the child to hold the chopsticks at designated positions. Further, the fixing ring is provided as a spiral structure which functions mainly to fix the tip of the finger, rather than a simple ring of the traditional chopsticks which can only receive the finger. In the embodiment provided in the present application, it is the fingertips that the child use to exert force when using the chopsticks, because the fingertips can be fixed by the spiral rings.

3. In the present application, one chopstick cannot be rotated after being connected to the connecting assembly, and the other chopstick can be rotated after being connected to the connecting assembly, which prevents children from not knowing how to apply force to the chopsticks and allows children to learn the knack of using chopsticks more quickly.

4. An elastic element is provided between two chopsticks. For example, the elastic element can be in an elongated shape. When one chopstick is rotated, the elastic element will be pressed and deformed. When one chopstick is not rotated, the elastic element will return to its original shape and generate an elastic force, so that the two chopsticks are in an engaged configuration, and the elastic element is restricted by the center hole on the front and rear clamping boards and the lower limiting element. The top portions of two chopsticks are separated, and the elastic component is springing outward, such that the elastic element cannot be loosened and can only be deformed in a defined direction. Further, the elastic member of the chopsticks can be replaced to adjust the elasticity according to the requirements of the user.

Other features and advantages of the present invention will be explained in the subsequent description, and partly become obvious from the description, or be understood by implementing the technical solutions of the present invention. The objects and other advantages of the present invention can be achieved and obtained through the structures and/or processes specifically pointed out in the description, claims, and drawings.

### BRIEF DESCRIPTION OF THE DRAWINGS

FIG. 1 is a first three-dimensional schematic diagram of chopsticks according to one embodiment of the present invention.

FIG. 2 is a second three-dimensional schematic diagram of chopsticks according to one embodiment of the present invention.

FIG. 3 is an exploded schematic diagram of chopsticks according to one embodiment of the present invention.

FIG. 4 is a partial enlarged schematic diagram of FIG. 3.

FIG. 5 is a first partial exploded schematic diagram of chopsticks according to one embodiment of the present invention.

FIG. 6 is a second partial exploded schematic diagram of chopsticks according to one embodiment of the present invention.

Reference numbers in the figures

| | | |
|---|---|---|
| 110- first chopstick, | 112- first picking-up portion, | 114- first top portion, |
| 116- first hole, | 118- second hole, | 120- second chopstick, |
| 122- second picking-up portion, | 124- third hole, | 126- coupling portion, |
| 128- second top portion, | 130- connecting assembly, | 132-first clamping board, |
| 132a- projecting shaft, | 132b- projecting arc, | 132c- first projection, |
| 132d- second projection, | 132e- third projection, | 134- loop, |
| 136- second clamping board, | 136a- bar, | 136b- fourth projection, |
| 136c- fifth projection, | 136d- sixth projection, | 140- fixing ring, |
| 142- hollow portion, | 144- first inserting hole, | 146- second inserting hole, |
| 144b/146a- first end, | 144a- second end, | 150- bending element. |

### DETAILED DESCRIPTION OF THE INVENTION

In the following, the embodiments of the present invention will be described in detail with reference to the accompanying drawings and examples, so as to understand how the present invention uses technical means to solve technical problems and achieve the technical effect. The implementation process can be fully understood and implemented accordingly. It should be noted that these specific descriptions are only for those skilled in the art to more easily and clearly understand the present invention, rather than a limited interpretation of the present invention; and as long as there is no conflict, the various embodiments of the present invention and the features in the various embodiments can be combined with each other, and the resulting technical solutions are within the scope of the present invention.

The technical solutions of the present invention are described in detail below through the drawings and specific embodiments.

### EXAMPLES

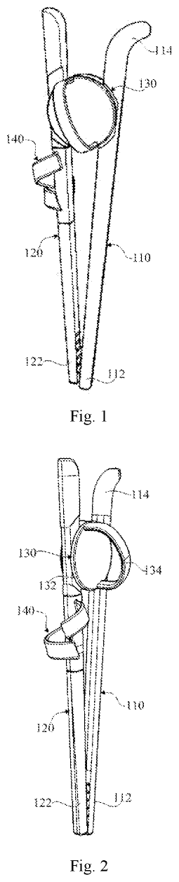

As shown in FIGS. 1 to 4, this embodiment provides chopsticks for children learning, comprising: a first chopstick 110, a second chopstick 120, and a connecting assembly 130 for connecting the first chopstick 110 with the second chopstick 120.

The connecting assembly 130 is provided with a connecting shaft allowing rotation of the first chopstick 110 and the second chopstick 120 relative to each other, wherein the connecting shaft is configured for connecting with a hole (the third hole 124) in the second chopstick 120, and is connected with a non-top portion of the second chopstick 120. In this respect, allowing rotation of the first chopstick 110 and the second chopstick 120 relative to each other means that at least one of the chopsticks is rotatable about the connecting shaft, such that the intersection angle formed by the first chopstick 110 and the second chopstick 120 is variable. The connection between the connecting shaft and the non-top portion of the second chopstick 120 can be formed at a position ⅕-½ away from the top of the chopstick.

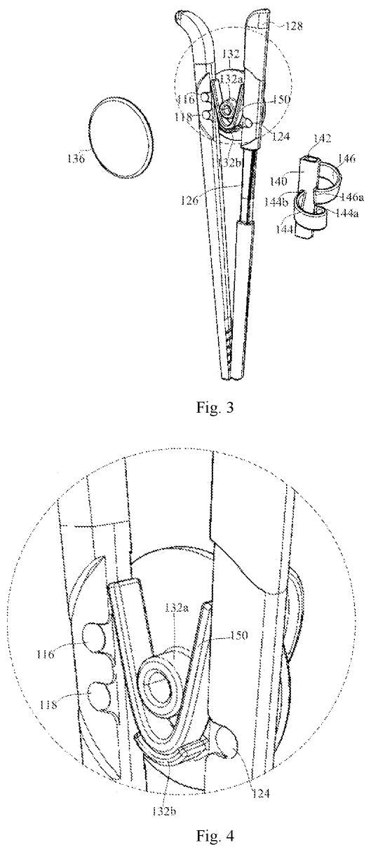

In another embodiment of the present application, the connecting shaft can be provided cooperating with the first chopstick 110. Specifically, in another embodiment, taking no account of the fixing ring provided in the chopsticks, the first chopstick 110 may also be provided with a same or similar connecting structure for cooperating with the connecting shaft in another position, such that the first chopstick 110 may also be rotatable about connecting shaft in the connecting assembly 130. In another embodiment, the connecting shaft may also be provided at a position in the center of the connecting assembly 130, such as at a position similar to the 132a in FIG. 3, and the first chopstick 110 and the second chopstick 120 can respectively be provided with a cooperating portion extending therefrom for connecting with the connecting shaft, such that both the first chopstick 110 and the second chopstick 120 can be rotatable about the same connecting shaft. In the present application, these different embodiments are not limited in any way.

It should also be understood that, with regard to the connecting shaft provided in the connecting assembly 130 allowing rotation of the first chopstick 110 and the second chopstick 120 relative to each other, it can be provided as the first projection 132c and 136d as mentioned below. It can also be provided that the connecting assembly 130 is provided with recesses and the first chopstick 110 and the second chopstick 120 are provided with projections cooperating with the recesses at corresponding positions, such that the recesses allow rotation of the first chopstick 110 and the second chopstick 120. In this way, the recesses constitute the connecting shaft. In another embodiment, the connecting shaft may also be provided as an independent component, such as a cylindrical pivot, which is connected with the first clamping board 132 and the second clamping board 136 as mentioned below, allowing the first chopstick 110 and the second chopstick 120 be rotatable about the independent component. In this way, the independent component may constitute a part of the connecting assembly and constitute the above connecting shaft. All these different embodiments are within the scope of the present application, and are not limited in any way in the present application.

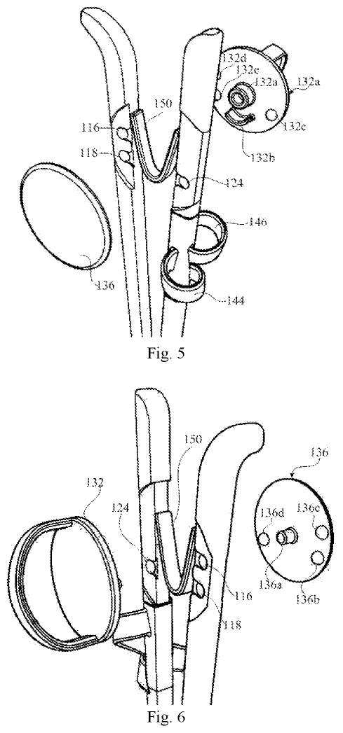

As shown in FIGS. 3 to 6, the connecting assembly 130 comprises a first clamping board 132 and a second clamping board 136. The first clamping board 132 and the second clamping board 136 are located respectively at two sides of the first chopstick 110 and the second chopstick 120 upon connection of first chopstick with the second chopstick. That is, when the two chopsticks are arranged side by side or when the two chopsticks are on the same plane, the first clamping board 132 and the second clamping board 136 are respectively placed on the two sides of the two chopsticks. The side where the first clamping board 132 is located is also called the front side, and the side where the second clamping board 136 is located is also called the back side.

In a further embodiment, the first clamping board 132 and the second clamping board 136 are respectively provided with a connecting portion for connecting with the first chopstick 110 and the second chopstick 120. Specifically, the connecting portion comprises at least two projections (the second projection 132d, the third projection 132e) on the first clamping board 132 for connecting with the first chopstick and also comprises the connecting shaft (the first projection 132c) for cooperating with the second chopstick 120. The first chopstick 110 is provided with a first hole 116 and a second hole 118 for cooperating with the second projection 132d and the third projection 132e. Since the first clamping board 132 and the first chopstick 110 are cooperating at two positions, the first chopstick 110 is not rotatable relative to the connecting assembly 130. It is obvious that more than two cooperating components can be provided to provide a non-rotatable connection. The second chopstick 120 is provided with a third hole 124 for cooperating with the first projection 132c, such that the second chopstick 120 is rotatable relative to the first projection 132c.

Since the chopsticks are fixed with two clamping boards, the connecting components that connect the two chopsticks can be manufactured and assembled more quickly. Further, there are no other parts exposed, thus a more stable structure can be provided. At the same time, the two chopsticks are on the same plane, so that the problem of not being able to clamp the food due to misalignment of the chopsticks can be avoided.

In a preferred embodiment, the second clamping board 136 is also provided with structures similar to those in the first clamping board 132. Specifically, the second clamping board 136 is also provided with a fourth projection 136b and a fifth projection 136c for respectively cooperating with the first hole 116 and the second hole 118, and a sixth projection 136d for cooperating with the third hole 124.

In addition, in another embodiment, the first clamping board 132 and the second clamping board 136 can be connected in an inverted connection or a buckle connection, or can be connected by heat welding, or can be engaged by an interference fit of a projection and a hole as mentioned above. These different embodiments are all within the scope of the present application, and are not limited in any way in the present example.

The chopsticks according to the present example further comprise an elastic element located inside the connecting assembly. When the elastic element is in a natural configuration, a picking-up portion of the first chopstick and a picking-up portion of the second chopstick are in a first configuration, and when the elastic element is in a compressed configuration, the picking-up portion of the first chopstick and the picking-up portion of the second chopstick are in a second configuration that is different from the first configuration.

As shown in FIGS. 3 to 6, in a preferred embodiment of the present example, the chopsticks further comprise an elastic element located inside the connecting assembly. When the elastic element is in a natural configuration, the picking-up portion 112 of the first chopstick 110 and the picking-up portion 122 of the second chopstick 120 are in an engaged configuration, and when the elastic element is in a compressed configuration, the picking-up portion 112 of the first chopstick 110 and the picking-up portion 122 of the second chopstick 120 are in a separated configuration.

It is obvious that the elastic element in FIGS. 3 to 6 can also be provided as a structure rotatable around the projecting shaft 132a, wherein when the elastic element is in a natural configuration, the picking-up portion of the first chopstick 110 and the picking-up portion of the second chopstick 120 are in a separated configuration, and when the elastic element is in a compressed configuration, the picking-up portion of the first chopstick 110 and the picking-up portion of the second chopstick 120 can be transferred from the separated configuration into an engaged configuration. As long as the following requirements can be met, it falls within the scope of the present application.

A first intersection angle is formed by the first chopstick 110 and the second chopstick 120 in the first configuration, and a second intersection angle is formed by the first chopstick 110 and the second chopstick 120 in the second configuration, wherein the first intersection angle is not equal to the second intersection angle.

Since the two chopsticks are connected by the connecting assembly 130 and can be rotated relative to the connecting shaft, and the connecting shaft is provided at a position other than the top of the chopsticks, it provides a more reasonable rotating position and a more reasonable leverage, and is more ergonomic. Further, it can effectively guide children to hold the chopsticks at designated positions, and the holding positions are almost the same as the positions when actually using ordinary chopsticks. Moreover, since the chopsticks are fixed with two clamping boards, the connecting components that connect the two chopsticks can be manufactured and assembled more quickly. Further, there are no other parts exposed, thus a more stable structure can be provided. At the same time, the two chopsticks are on the same plane, so that the problem of not being able to clamp the food due to misalignment of the chopsticks can be avoided. Through the elastic element, children can save more effort when clamping food, and the two chopsticks can automatically restore their initial configuration.

As shown in FIGS. 1 and 2, in a preferred embodiment of the present example, an end (the first top portion 114) of the first chopstick 110 is provided with an arc-shaped anti-drop handle, and the anti-dropping handle is curved and extends outward along the direction in which the two chopsticks are separated.

As shown in FIGS. 1 and 2, a loop 134 for fixing a thumb of the child is provided at an outer side wall of the connecting assembly 130. Specifically, the loop 134 is provided on the first clamping board (also called the front clamping board), and the loop 134 is provided in a shape that allows passing through of the thumb, which makes it difficult for the chopsticks to be dropped and makes it easier for the child to hold the chopsticks firmly when using the chopsticks.

As shown in FIGS. 3 to 6, in a preferred embodiment of the present example, the chopsticks further comprise a fixing ring 140 located on the second chopstick, wherein the fixing ring 140 is configured for receiving a fingertip of the child, and the picking-up portion 122 of the second chopstick 120 can be driven into rotation about the connecting shaft by the fingertip (for example, the index finger and/or middle finger) through the fixing ring. In a further preferred embodiment, the connecting shaft of the connecting assembly 130 cooperates with the second chopstick 120 while the first chopstick 110 is non-rotatable relative to the connecting assembly 130, and the fixing ring 140 comprises a spiral ring such that only the second chopstick 120 is rotatable when the fingertip of the child is inserted into the fixing ring 140.

In a more specific embodiment, the fixing ring 140 comprises two spiral rings, wherein the first and the second spiral rings are both connected to a columnar component having a hollow portion 142, and a first inserting hole 144 and a second inserting hole 146 are formed respectively between the first and the second spiral rings and the columnar component 142, and a middle portion of the second chopstick 120 (the coupling portion 126) can be inserted into the hollow portion 142 of the columnar component. Moreover, a first end 146a of the first spiral ring connected with the second chopstick 120 and a second end 144a of the second spiral ring connected with the second chopstick are in the same axial direction (i.e., the direction along the length of the chopstick), while the first end 146a of the first spiral ring connected with the second chopstick and a first end 144b of the second spiral ring connected with the second chopstick are distributed perpendicular to the axial direction (i.e., perpendicular to the direction of the length of the chopstick).

Therefore, the child's fingertips are received in the fixing ring 140, which greatly increases the contact area between the fingers and the ring, making it not easy to loosen; and the child's fingertips can drive the picking-up portion 122 of the second chopstick 120 to rotate about the connecting shaft through the fixing ring 140, which can better guide the child to hold the chopsticks at designated positions. Further, the fixing ring 140 is provided as a spiral structure which functions mainly to fix the tip of the finger, rather than a simple ring of the traditional chopsticks (the ring can only receive fingers). In the embodiment provided in this example, it is the fingertips that the child use to exert force when using the chopsticks, because the fingertips can be fixed by the spiral rings.

In this example, one chopstick cannot be rotated after being connected to the connecting assembly 130, and the other chopstick can be rotated after being connected to the connecting assembly 130, which prevents children from not knowing how to apply force to the chopsticks and allows children to learn the knack of using chopsticks more quickly.

As shown in FIGS. 3 to 6, in a preferred embodiment, the elastic element is provided as a bending element 150 that is deformable, wherein the bending element comprises two ends in engagement respectively with the inner side of the first chopstick 110 and the inner side of the second chopstick 120, with the engagement formed at a position closer to the top portion of the first chopstick 110 and the top portion of the second chopstick 120 respectively relative to the picking-up portion 112 of the first chopstick 110 and the picking-up portion 122 of the second chopstick 120. Specifically, similar to the position of the connecting shaft mentioned above, the engagement position can be formed at a position ⅕-½ away from the top of the chopstick.

In a preferred embodiment, the first clamping board 132 of the connecting assembly 130 is provided with a projecting shaft 132a and a projecting arc 132b located below the projecting shaft 132a, and the second clamping board 132 is provided with a bar 136a which can be inserted into a hole in the shaft 132a. It is obvious that the projecting shaft 132a and the projecting arc 132b can also be provided on the second clamping board 136, and alternatively, the two clamping boards can be provided respectively with the projecting shaft 132a and the projecting arc 132b. The elastic element can be provided as an elastic sheet as shown in FIGS. 3 to 6, or as an element such as a torsion spring. The projecting arc 136b is configured for preventing the elastic sheet from falling, and two ends of the elastic sheet are located respectively at two sides of the projecting shaft 132a inside the connecting assembly.

Therefore, through the elastic element, it is more labor-saving for children to clamp food, and by replacing the elastic element, the elastic force can be adjusted so as to gradually release the children from the help of the elastic element. Specifically, an elastic element is provided between two chopsticks. For example, the elastic element can be in an elongated shape. When one chopstick (the second chopstick 120 with one hole) is rotated, the elastic element will be pressed and deformed. When one chopstick (the first chopstick 110 with two holes) is not rotated, the elastic element will return to its original shape and generate an elastic force, so that the two chopsticks are in an engaged configuration, and the elastic element is restricted by the center hole on the front and rear clamping boards and the lower limiting element. The top portions of two chopsticks are separated, and the elastic component is springing outward, such that the elastic element cannot be loosened and can only be deformed in a defined direction. Further, the elastic member of the chopsticks can be replaced to adjust the elasticity according to the requirements of the user.

Finally, it should be noted that the above description only discloses the best embodiment of the present invention, and does not limit the present invention in any form. Any person skilled in the art can make many possible changes and simple replacements to the technical solution of the present invention using the methods and technical solution disclosed above without departing from the scope of the present invention, which fall in the scope of the present invention.

1. Chopsticks for children learning, comprising:
a first chopstick,
a second chopstick, and
a connecting assembly for connecting the first chopstick with the second chopstick,
wherein the connecting assembly is provided with a connecting shaft allowing rotation of the first chopstick and the second chopstick relative to each other;
wherein the chopsticks further comprise a fixing ring located on the second chopstick, wherein the fixing ring is configured for receiving a fingertip of a child, and the picking-up portion of the second chopstick can be driven into rotation about the connecting shaft by the fingertip through the fixing ring; and
wherein the fixing ring comprises two spiral rings such that only the second chopstick is rotatable when the fingertip of a child is inserted into the fixing ring.

2. (canceled)

3. The chopsticks according to claim 1, wherein the connecting shaft of the connecting assembly cooperates with the second chopstick while the first chopstick is non-rotatable relative to the connecting assembly.

4. The chopsticks according to claim 1, wherein a first end of a first spiral ring connected with the second chopstick and a second end of a second spiral ring connected with the second chopstick are in the same axial direction, and the first end of the first spiral ring connected with the second chopstick and a first end of the second spiral ring connected with the second chopstick are distributed perpendicular to the axial direction.

5. The chopsticks according to claim 1, wherein an elastic element is located inside the connecting assembly, wherein when the elastic element is in a natural configuration, a picking-up portion of the first chopstick and a picking-up portion of the second chopstick are in a first configuration, and when the elastic element is in a compressed configuration, the picking-up portion of the first chopstick and the picking-up portion of the second chopstick are in a second configuration that is different from the first configuration, and wherein a first intersection angle is formed by the first chopstick and the second chopstick in the first configuration, and a second intersection angle is formed by the first chopstick and the second chopstick in the second configuration, wherein the first intersection angle is not equal to the second intersection angle.

6. The chopsticks according to anyone of claim 1, wherein the connecting assembly comprises a first clamping board and a second clamping board located respectively at two sides of the first chopstick and the second chopstick upon connection of first chopstick with the second chopstick, and the first clamping board and the second clamping board are respectively provided with a connecting portion for connecting with the first chopstick and the second chopstick, and wherein the connecting portion comprises at least two projections for connecting with the first chopstick and also comprises the connecting shaft for cooperating with the second chopstick, and the first chopstick is provided with holes for cooperating with the projections and the second chopstick is provided with a hole for cooperating with the connecting shaft.

7. The chopsticks according to claim 5, wherein the elastic element is provided as a bending element that is deformable, wherein the bending element comprises two ends in engagement respectively with an inner side of the first chopstick and an inner side of the second chopstick, with the engagement formed at a position closer to a top portion of the first chopstick and a top portion of the second chopstick respectively relative to the picking-up portion of the first chopstick and the picking-up portion of the second chopstick.

8. The chopsticks according to claim 7, wherein the connecting assembly is provided with a projecting shaft and a projecting arc located below the projecting shaft, wherein the elastic element is provided as an elastic sheet, and the projecting arc is configured for preventing the elastic sheet from falling, and two ends of the elastic sheet are located respectively at two sides of the projecting shaft inside the connecting assembly.

9. The chopsticks according to claim 1, wherein an end of the first chopstick is provided with an arc-shaped anti-drop handle.

10. The chopsticks according to claim 1, wherein a loop for fixing a thumb of a child is provided at an outer side wall of the connecting assembly.

11. The chopsticks according to claim 1, wherein the connecting shaft is connected with a non-top portion of the first chopstick and/or the second chopstick.

12. The chopsticks according to claim 1, wherein the two spiral rings are both connected to a columnar component having a hollow portion, and a first inserting hole and a second inserting hole are formed respectively between the two spiral rings and the columnar component, and a middle portion of the second chopstick can be inserted into the hollow portion of the columnar component.
